(19) United States
(12) Patent Application Publication
(10) Pub. No.: US 2002/0110330 A1
(43) Pub. Date: Aug. 15, 2002

(54) Packaging for fiber optic device

(75) Inventors: Jeffrey A. Brogan, Port Jefferson, NY (US); Michael A. Centanni, Parma, OH (US)

Correspondence Address: MARK KUSNER COMPANY LPA, HIGHLAND PLACE SUITE 310, 6151 WILSON MILLS ROAD, HIGHLAND HEIGHTS, OH, 44143

(73) Assignee: Gould Optronics Inc.

(21) Appl. No.: 09/971,192

(22) Filed: Oct. 4, 2001

Related U.S. Application Data
(63) Continuation-in-part of application No. 09/734,260, filed on Dec. 11, 2000.

(51) Int. Cl. G02B 6/26; G02B 6/00

(52) U.S. Cl. 385/51; 385/95; 385/134

(57) ABSTRACT

A package for a fiber optic device or fiber optic component having at least one optical fiber extending therefrom. The package is comprised of a support substrate for supporting the optical device or optic component, the support substrate having at least one optical fiber extending therefrom. A housing surrounds the substrate and has an opening at one end. At least one optical fiber extends through the opening. A layer of metal seals the opening of each end of the tube and the glass fiber cladding where the optical fiber extends through the layer of metal. The layer of metal is applied using a thin film deposition process, such as ion-beam assisted deposition, electron-beam deposition, or ion-beam deposition.

### FIELD OF THE INVENTION

The present invention relates to packaging for fiber optic devices and optic components such as couplers, splitters, sensors and the like, and more particularly to a fiber optic package, and process for forming the fiber optic package, that hermetically seals the optical device or optic component from external environmental conditions.

### BACKGROUND OF THE INVENTION

The widespread and global deployment of fiber optic networks and systems mandates that fiber optic equipment and components operate reliably over long periods of time. This mandate imposes stringent performance requirements on various fiber optic components that are used in such networks and systems. In this respect, since fiber optic components are expected to operate reliably in hostile environments, prior to qualification for use, such components are typically subjected to an array of mechanical and environmental tests that are designed to measure their performance. One of these tests is a damp/heat soak test, wherein a fiber optic component is exposed to elevated temperature and humidity conditions (typically 85° C and 85% relative humidity) for an extended period of time. Fiber optic couplers exposed to such conditions exhibit a gradual drift in insertion loss. Eventually this drift will cause a coupler to fail to meet its assigned performance specifications.

It is believed that the primary cause for failure is water vapor or some component, constituent or by-product of water vapor diffusing into the exposed core glass of the coupler and changing its index of refraction. In an attempt to prevent migration of moisture into the coupling region, it has been known to package fiber optic couplers and other optic components inside metal tubing and to seal the ends of the tubing with a polymeric material, such as a silicon-based material or epoxy. These types of materials have not proved successful in preventing the aforementioned problem.

The present invention provides a packaging for a fiber optic component, wherein the optic component is enclosed by a barrier layer, which is formed using one or more thin film deposition processes.

### SUMMARY OF THE INVENTION

In accordance with the present invention, there is provided a method of packaging a fiber optic device having at least one optical fiber extending therefrom, including the steps of: (a) mounting a fiber optic device having at least one optical fiber extending therefrom onto a substrate; (b) enclosing said fiber optic device within a cavity in a structure having at least one opening therein through which said at least one optical fiber extends; and (c) depositing a thin film of one or more target materials to form a generally continuous moisture impervious barrier layer over at least said opening and said optical fiber, wherein said barrier layer is comprised of one or more layers, and closes said opening in said structure and seals said cavity.

In accordance with another aspect of the present invention, there is provided a packaged, optical device, comprised of: (a) an optical device having at least one optical fiber extending therefrom; (b) a structurally rigid housing encasing said optical device, said housing having an internal cavity for containing said optical device and at least one opening in said housing communicating with said cavity, said optical fiber extending through said opening; and (c) a continuous, barrier layer on said housing at least in the vicinity of said opening, said barrier layer covering said housing in the vicinity of said opening and a portion of the optical fiber extending through said opening and covering said opening to seal said optical device within said housing, wherein one or more layers are deposited using a thin film deposition process to form said barrier layer.

It is an object of the present invention to provide packaging for a fiber optic component or a fiber optic device.

It is an object of the present invention to provide packaging as described above for a fiber optic component or a fiber optic device including generally continuous optical fibers.

It is another object of the present invention to provide packaging for a fiber optic coupler.

Another object of the present invention is to provide packaging as described above that hermetically seals the fiber optic component or fiber optic device from the surrounding environment.

Another object of the present invention is to provide a packaging as described above which includes a barrier layer that is formed, at least in part, by a thin film deposition process, including by not limited to, electron-beam deposition, ion-beam deposition, and ion-beam assisted electron-beam deposition.

Another object of the present invention is to provide packaging as described above that does not require the use of precision components to achieve hermetic sealing of the optical fibers.

A still further object of the present invention is to provide packaging as described above that retards or prevents slow drift in insertion loss in couplers due to damp/heat environments.

These and other objects will become apparent from the following description of a preferred embodiment taken together with the accompanying drawings and the appended claims.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1 is a partially sectioned, perspective view of a housing of an exemplary packaged fiber optic device;

FIG. 2 is a block diagram of a deposition system for forming a moisture barrier layer onto at least a portion of the housing of a fiber optic device, according to a preferred embodiment of the present invention;

FIG. 3 is a graph illustrating the results of a damp/heat soak test (i.e., change in insertion loss) for a fiber optic coupler constructed in accordance with EXAMPLE 1; and

FIG. 4 is a graph illustrating the results of a damp/heat soak test (i.e., change in insertion loss) for a fiber optic coupler constructed in accordance with EXAMPLE 2.

### DETAILED DESCRIPTION OF PREFERRED EMBODIMENT

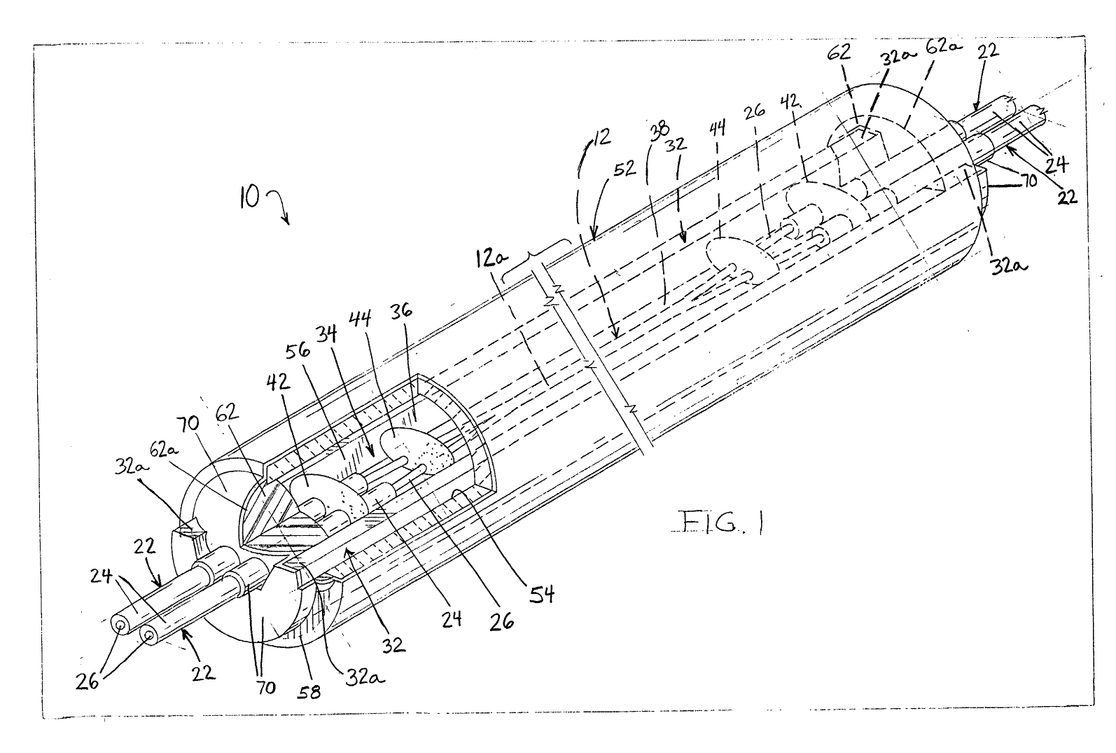

Referring now to the drawings wherein the showings are for the purpose of illustrating the preferred embodiment of the invention only, and not for the purpose of limiting same, FIG. 1 shows a package 10 for enclosing a fiber optic device. (In the drawings, the respective parts in many instances are not drawn to scale, and in some instances are exaggerated for the purpose of illustration). In the embodiment shown, package 10 encloses a 2×2 fiber optic coupler 12. It will, of course, be appreciated that other types of fiber optic components or fiber optic devices may be enclosed within package 10, in accordance with the present invention. In the art, the term “optic device” generally refers to active elements or apparatus; whereas, the term “optic component” generally refers to elements or apparatus that are passive. The present invention is applicable to both fiber optic devices and fiber optic components. Accordingly, as used herein, the term “optic device(s)” shall refer both to optic devices and optic components.

Coupler 12 is formed from two or more continuous optical fibers, designated 22, that have been coupled by a conventionally known method. Coupler 12 in and of itself forms no part of the present invention. Coupler 12 has a coupling region, designated 12a. Each fiber has an outer jacket or buffer 24 comprised of a polymeric material that surrounds inner glass fiber cladding 26. As is conventionally understood, jackets or buffers 24 of fibers 22 are removed along a portion of their length to facilitate the manufacturing of a coupler.

Coupler 12 is supported on a substrate 32. In the embodiment shown, substrate 32 is a cylindrical rod having a longitudinally extending groove 34 formed therein. Groove 34 is generally defined by a pair of planar, sloping side surfaces 36 and a planar bottom surface 38. Substrate 32 is provided to support coupler 12. In the embodiment shown, coupler 12 is mounted to substrate 32 by a small amount of epoxy 42 disposed on opposite sides of coupling region 12a. The primary purpose of epoxy 42 is to hold coupler 12 in place upon substrate 32 until coupler 12 is subsequently secured to substrate 32 by a glass-based bonding composition 44. Composition 44 is comprised essentially of glass powder and a volatile solvent in a slurry form. The slurry is allowed to dry by allowing the volatile solvent to evaporate, resulting in a generally solid mass that is softened, preferably by a laser, to bond glass fibers 26 of optical fibers 22 to substrate 32. In this respect, bonding composition 44 and substrate 32 are preferably formed of glass having similar physical properties, e.g., coefficient of thermal expansion, as the glass forming the cladding of fibers 22. A suitable glass-based bonding composition is disclosed in prior U.S. Pat. Nos. 5,500,917 and 5,682,453, both to Daniel et al., the disclosures of which are expressly incorporated herein by reference.

With coupler 12 mounted to substrate 32, a tube 52 is positioned around substrate 32. In the embodiment shown, tube 52 is cylindrical in shape, and has an inner cylindrical surface 54 defining a cylindrical inner bore or opening. The inner bore is dimensioned to be slightly larger than the diameter of substrate 32, so that tube 52 receives substrate 32 in close mating fashion. Tube 52 is preferably formed of glass composition similar to that of substrate 32. Tube 52 is preferably shorter than substrate 32, such that end portions 32a of substrate 32 extend beyond each end of tube 52. Each end portion 32a defines a ledge or shelf that supports optical fibers 22 as they extend from tube 52. Between substrate 32 and inner surface 54 of tube 52, an elongated cavity or passage 56 is defined through tube 52. A seam 58 is defined between the bottom of substrate 32 and tube 52.

In the context of the present invention, tube 52 is essentially a rigid, structural housing provided to contain and protect coupler 12 and more particularly, to surround and protect coupling region 12a. Tube 52 has an interior cavity that provides space around coupling region 12a for the operation thereof. Although a cylindrical tube 52 is illustrated in the drawings, other types of housing structures may be used to contain coupler 12. Such housing need only have the structural integrity required to protect coupler 12, and have at least one opening to allow optic fibers 22 to exit the housing. As will be appreciated by those skilled in the art, from a further reading of the specification, the housing containing coupler 12 need not be tubular, and need not be a single piece structure. In this respect, multi-piece structures may be used to form the housing enclosing and surrounding coupler 12. Further, substrate 32 may even constitute part of a housing assembly, such as when used in combination with a cover plate covering substrate 32.

Further, while tube 52 is described as being formed of glass, tube 52 or any housing structure, may also be formed of quartz, metal or plastic. Since an object of the present invention is to try to hermetically seal an optic device or optical component from external environmental conditions, glass, quartz and metal that have good characteristics with respect to moisture penetration are preferred materials. However, relatively porous materials, such as certain plastics, may find advantageous application in forming a housing structure, i.e., tube 52, as long as the entire housing structure is coated in accordance with the present invention.

With substrate 32 within glass tube 52, the ends of glass tube 52 are preferably plugged with a mass 62 of an adhesive/sealant material. Mass 62 may be applied into groove 34 on end portion 32a. Groove 34 on portion 32a forms a receptacle to receive mass 62 that may be in an uncured, viscous state. In this respect, as will be appreciated by those skilled in the art, fibers 22, substrate 32 and glass tube 52 are extremely small. For example, the diameter of each optical fiber 22 may be about 250 μm and the diameter of substrate 32, which is essentially a cylindrical rod having a groove formed therein is about 0.07 inches (0.1778 cm). Glass tube 52 would preferably have an inner diameter only slightly larger than the diameter of substrate 32 and an outer diameter to produce a tube wall thickness of about 0.03 inches (0.079 cm).

At these sizes, it is difficult to physically insert an adhesive/sealant material into the interior of tube 52 past substrate 32 and optical fibers 22. By providing extension portion 32a, groove 34 in substrate 32 provides a convenient receptacle to receive the adhesive/sealant material, wherein the ends of tube 52 and the surface of substrate 32 provide sufficient surface area for even small droplets of material to wet and form a bead around optical fibers 22 and the end surface of tube 32. In one respect, mass 62 is provided to secure substrate 32 to tube 52 to prevent relative displacement of these components during subsequent processing. In another respect, mass 62 plugs and closes the ends of glass tube 52, thereby forming a first protective barrier between coupling region 12a and the external environment. Mass 62 defines an outer surface 62a at the end of tube 52. Mass 62 is preferably formed of a material with good adhesive properties to both glass and metal. A thermoplastic or thermosetting polymeric material may be used to form mass 62. Thermosetting polymer materials such as epoxy resins or urethanes may be used. Mass 62 may be preferably formed of a thermoplastic having a softening temperature of between 100° C and 370° C. Preferred materials for forming mass 62 are polyimide and acrylic polymers. In the embodiment shown in FIG. 1 optical fibers 22 extend through mass 62. Where optical fibers 22 extend through mass 62, the outer jacket or buffer 24 remains around inner glass fiber claddings 26.

With substrate 32 disposed within tube 52, and with each end of tube 52 plugged by mass 62, a moisture barrier layer 70 is applied at least to the end portions of tube 52, end portions 32a of substrate 32, surfaces 62a and optical fibers 22. In accordance with a preferred embodiment of the present invention, barrier layer 70 also covers tube 52, so as to completely encapsulate the fiber optic device. As used herein, the term “moisture barrier” refers to any material that significantly prevents or retards moisture penetration. Barrier layer 70 is preferably comprised of one or more sub-layers of a metal, a metal alloy, a glass or a ceramic (e.g., metal oxide, metal nitride, and metal carbide), or a cermet (ceramic-metal composite structure), including combinations thereof. In addition, polymeric materials may be used in combination with the above-mentioned material classifications. It should be understood that the term “metal” is inclusive of such materials as silicon, which is commonly known as a “nonmetallic.” Compositions of these types of material are recognized to provide a moisture barrier that would effectively seal the fiber optic device from external environmental conditions.

Barrier layer 70 is preferably formed by a thin film deposition process as will be described in detail below. It should be understood that the term “thin film deposition” is inclusive of Physical Vapor Deposition (PVD) and Chemical Vapor Deposition (CVD). PVD is used in accordance with a preferred embodiment of the present invention. PVD includes the processes of evaporation, ion-beam assisted electron beam deposition, and “sputtering” (which includes ion beam deposition).

Evaporation includes processes such as electron beam evaporation (also referred to herein as “electron beam deposition”), as well as processes wherein a material is heated inside a chamber by a heater to form a vapor, without use of an electron beam. The heating is classified as (a) resistive or (b) inductive. The evaporation processes which do not use an electron beam are commonly used to deposit SiO₂ or SiO thin films, and can also be used in conjunction with an ion-beam assist. Ion-beam assisted evaporation (with and without use of an e-beam) are collectively referred to herein as “ion-beam assisted deposition.”

Sputtering refers to a glow discharge process whereby bombardment of a cathode releases atoms from the surface which then deposit onto a nearby surface to form a coating. For example, sputtering occurs when energetic ionized particles impinge on the surface of a target material, causing the emission of particles and erosion of the surface of a solid. This particular sputtering process is also referred herein to as “ion beam deposition.”

At a lower limit, the thickness of each layer of barrier layer 70 is the minimum thickness necessary to form a continuous, non-pervious layer over surface 62a of mass 62, at least the ends of glass tube 52 and substrate 32, and the surface of optical fibers 22 extending through mass 62. For example, each layer comprising barrier layer 70 may have a thickness of 10 nm to 1000 nm, preferably 100 nm-300 nm (0.1-0.3 microns).

While any metal is suitably used as a layer of barrier layer 70, the metal preferably has good adhesive properties to glass tube 52 and to the material forming mass 62, which may take the form of an epoxy. Furthermore, the metal film should be deposited as to produce a non-porous, dense thin-film and preferably be compatible with both glass and epoxy surfaces. Examples of such metals include, but are not limited to: aluminum, zinc, copper, nickel, tin, tin/lead, tin/zinc, aluminum bronze, phosphor bronze, steel, stainless steel, monel, gold, molybdenum, titanium, chromium, silver, palladium, zirconium, silicon, tungsten, tantalum, boron, vanadium, cobalt, magnesium, magnetic metals such as rhenium, terbium, and gadolinium, as well as metal alloys of the above-mentioned metals (e.g., brass, bronze, NiAl, MoS₂, and the like). Of the metals disclosed above, zinc, aluminum, nickel, chromium, tin, lead and alloys thereof are more preferably used to form a metal barrier layer 70 because of their adhesion to glass and epoxy, and the ability to be processed via a thin film deposition process.

Glasses are a specific sub-category of ceramics, and normally contain at least 50 percent silica. Glasses are also amorphous structures which differ from ceramics, which are crystalline. Examples of suitable glasses include, but are not limited to: soda-lime glass; lead glass; borosilicate glass; aluminosilicate glass; and fused silica glass.

Examples of suitable ceramics include, but are not limited to: (I) metal oxides (e.g., silica, silicon monoxide, alumina, titania, alumina-titania, zirconia, mullite, nickel oxide, chromium oxide, cerium dioxide, magnesium oxide, zinc oxide and mixtures thereof); (II) metal nitrides (e.g., aluminum nitride, silicon nitride, boron nitride and mixtures thereof); and (III) metal carbides (e.g., molybdenum carbide, tungsten carbide, titanium carbide, vanadium carbide, diamond-like carbon (DLC) and mixtures thereof).

Examples of suitable cermets include, but are not limited to: aluminun/alumina, zirconium/zirconia, nickel/nickel oxide, titanium/titania, chromium/ chromium oxide, silicon/silica or aluminum/aluminum nitride.

In accordance with a preferred embodiment of the present invention, barrier layer 70 is applied by a thin film deposition process As indicated above, thin film deposition includes (but is not limited to) the processes of (a) ion-beam (i-beam) assisted deposition, as well as (b) electron-beam (e-beam) deposition and (c) ion-beam (i-beam) deposition.

Ion-beam assisted electron-beam deposition is a vacuum-deposition process that combines physical vapor deposition (PVD) with ion-beam bombardment. A vapor of coating atoms is generated when an electron beam contacts the target material and is then subsequently deposited on a substrate material (i.e., e-beam deposition). Ions are simultaneously extracted from a plasma produced by an ion source and accelerated into the grown PVD film at energies ranging from several hundred to several thousand electron volts. It has been recognized that the stability and adhesion of a moisture barrier layer is significantly improved for layers where the growing film has been bombarded with low-energy ions during deposition. These ion-assisted techniques provide energy to the growing film at the substrate material surface resulting in higher packing densities and hence greater stability. As indicated above, ion-beam assist can also be used in conjunction with an evaporation process which does not use an e-beam

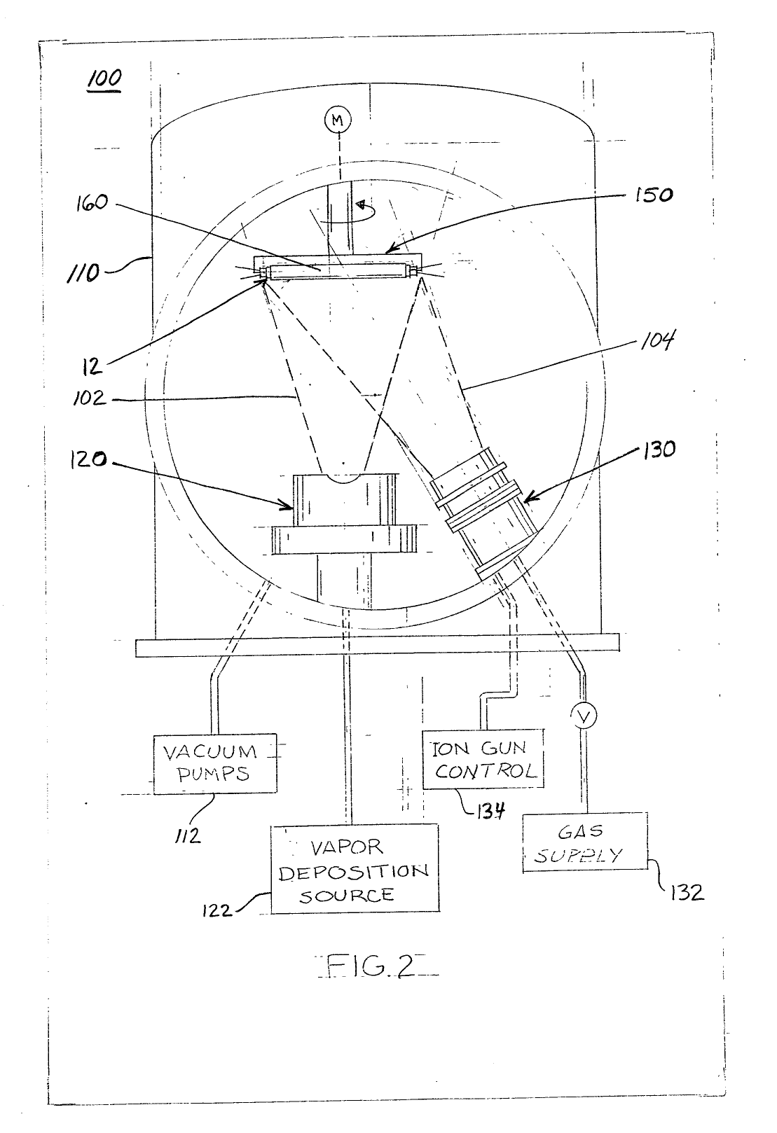

Referring now to FIG. 2, there is shown a block diagram of a deposition system 100 for forming barrier layer 70, according to a preferred embodiment of the present invention. Deposition system 100 is generally comprised of a vacuum chamber 110 and associated vacuum pumps 112, an electron beam evaporator 120 and associated vapor deposition source 122, an ionizer 130 and associated gas supply 132 and associated ion gun control 134, and a rotatable holder 150.

Vacuum chamber 110 houses e-beam evaporator 120, ionizer 130 and holder 150. Vacuum pumps 112 are provided to generate a vacuum within vacuum chamber 110 in a conventionally known manner.

E-beam evaporator 120 contains the source material to produce a thin film. The source material may be in the form of a powder, pellet or slug. An electron beam is focused on the source material producing a vapor of coating atoms 102 inside vacuum chamber 110.

Ionizer 130 receives gas from a gas supply 132 in a conventionally known manner to produce energized ions 104 inside vacuum chamber 110. A valve V is provided to control the flow of gas from gas supply 132. Ion gun control 134 controls the release of energized ions from ionizer 130. Ionizer 130 ionizes gases, including, but not limited to, argon, oxygen and nitrogen.

Holder 150 is rotatable about an axis generally co-linear with the longitudinal axis of e-beam evaporator 120. A motor M is provided to rotate holder 150. Holder 150 includes a structure for gripping a fiber optic coupler 12. Fiber optic coupler 12 is preferably gripped by holder 150 at outward extending ends of optical fibers 22, wherein the gripped portion of optical fibers 22 do not require coating atoms 102.

It should be appreciated that the ion bombardment provided by ionizer 130 controls film (i.e., barrier layer) properties in i-beam assisted e-beam deposition. In this regard, ions 104 impart substantial energy to the coating and coating/substrate interface. This achieves the benefits of substrate heating (which provides denser films) without significantly heating the substrate. Ions 104 also interact with coating atoms 102, driving them to the substrate surface which increases adhesion. The combination of e-beam evaporation and i-beam bombardment produces uniform, strongly adherent, low-stress films of any coating material on most substrate materials, including polymers.

The major parameters of the i-beam assisted e-beam deposition include coating material, evaporation rate, ion species, ion energy, and ion beam current density. In contrast, in conventional e-beam deposition, evaporated material is condensed onto a substrate to form a thin film. Accordingly, the only controllable factors in an e-beam deposition process are coating material, evaporation rate, and substrate temperature. It should be understood that an electron-beam deposition process includes evaporation and deposition steps, whereas an i-beam assisted e-beam deposition includes evaporation, ionization, acceleration and deposition steps.

As indicated above, there are several deposition processes by which a barrier layer 70 may be suitably formed. The preferred process for formation of barrier layer 70 is ion-beam assisted deposition, as will be described in detail below. Other suitable processes include e-beam deposition and i-beam deposition.

It should be understood that prior to formation of barrier layer 70, a “sputter” cleaning process is preferably performed on surfaces upon which barrier layer 70 is to be formed. The surfaces to be cleaned are the fiber optic coupler enclosures. It has been recognized that sputter cleaning of these surfaces results in improved adhesion of the coating atoms of barrier layer 70. The sputter cleaning process may include use of an ion-beam, such as an argon ion-beam. Other suitable gases for sputter cleaning include, but are not limited to, oxygen and nitrogen.

Set forth below is a summary of steps for surface preparation and a coating deposition process in accordance with an exemplary embodiment of the present invention, wherein ion-beam sputter cleaning is used for surface preparation, and ion-beam assisted electron-beam deposition is used to form barrier layer 70.

1. Fiber optic enclosures are cleaned with acetone and methanol.

2. Fiber optic coupler regions are masked (e.g., with Kapton™ tape).

3. Fiber optic coupler enclosures are mounted in a rotating holder inside vacuum chamber 110.

4. Vacuum chamber 110 is pumped down with vacuum pumps 112 (e.g., mechanical roughing pumps and turbo pumps) to pressures of approximately 10⁻⁷ torr.

5. Fiber optic coupler enclosures are rotated and cleaned using an ion beam produced by ionizer 130. The ion-beam sputter cleans the surface prior to deposition. It should be appreciated that in-situ cleaning of the fiber optic coupler enclosures prior to material deposition increases film adhesion and reduces contamination at the interface. As indicated above, ion beam cleaning is important to maximize adhesion.

6. An e-beam evaporation system utilizes one or more electron beams focused on one or more source materials (e.g., metals, ceramics, etc.). For example, the following process can be conducted and controlled:

(i) stationary electron beam deposition of one source material;

(ii) swept electron beam deposition of one source material;

(iii) simultaneous dual electron beam deposition of two different source materials;

(iv) electron beam deposition of one source material, followed by ion-beam assisted electron beam deposition of another source material; and

(v) ion-beam assisted electron beam deposition of one source material followed by electron beam deposition of another source material.

These processes can, therefore, produce a range of coating designs, including designs ranging from a single metal layer followed by a single oxide film to multiple alternating layers of metal and oxide layers.

In the case of ion-beam assisted e-beam deposition, the chemistry of the electron beam deposited material can be altered using a reactive ion beam gas. For example, an aluminum thin film can be transformed to an aluminum oxide thin film using an oxygen ion source. Similarly, aluminum can be transformed to aluminum nitride using a nitrogen ion source. It should be understood that an argon ion source will not appreciably affect the aluminum chemistry since argon is chemically inert.

During the ion-beam cleaning and ion-beam assisted e-beam deposition process, the fiber optic couplers are preferably rotated in two different directions simultaneously to insure uniform coverage.

As indicated above, multiple thin films of different materials (i.e., layers of barrier layer 70) may be produced, each preferably ranging in thickness from 100 nm to 300 nm (0.1 microns to 0.3 microns). Multi-layer coatings may be produced by first depositing one target material and then changing to a second target material, without having to break vacuum. For example, first a metal layer may be formed, followed by formation of a metal oxide layer. Alternatively, a first metal layer may be formed followed by formation of one or more subsequent metal layers, where the same metal is used for each subsequent layer.

The following are some exemplary processes for forming barrier layer 70. Other processes are well known to those skilled in the art. A metal layer is suitably formed using electron-beam deposition with a metal target material, argon ion-beam deposition with a metal target material, and argon ion-beam assisted electron-beam deposition with a metal target material. A metal oxide layer (e.g., Al₂O₃, SiO₂) is suitably formed by electron beam deposition with ion beam assist, wherein the target material is a metal oxide, and the ion beam is an oxygen or argon ion beam; electron beam deposition with a metal oxide target material; or ion beam deposition with a metal oxide target material. A cermet layer (e.g., Al+Al₂O₃) is suitably formed by electron beam deposition of a metal with an oxygen ion beam assist, or the presence of oxygen in the vacuum chamber; electron beam deposition of a metal, in the presence of oxygen in the vacuum chamber; or ion beam deposition of a metal using an oxygen ion gun.

Examples of target material combinations include, but are not limited to:

(a) no cleaning, electron-beam deposition of aluminum thin film.

(b) no cleaning, electron-beam deposition of aluminum thin film, with argon ion-beam assist.

(c) no cleaning, electron-beam deposition of aluminum thin film, with oxygen ion-beam assist.

(d) sputter clean with (oxygen) ion beam, then electron-beam deposition of aluminum thin film.

(e) sputter clean with (oxygen) ion beam, then electron-beam deposition of aluminum thin film with oxygen ion-beam assist.

(f) sputter clean with (oxygen) ion beam, electron-beam deposition of aluminum thin film, then electron beam deposition of silicon with oxygen ion-beam assist, to produce silica (SiO₂) thin film.

As indicated above, housing, such as tube 32, may also be formed of a plastic material. Because of its porous, amorphous structure, if plastic is used to form a housing containing coupler 12, barrier layer 70 is preferably applied on the entire outer surface of the plastic housing, along with the opened end(s) of the structure, to form a barrier layer over the entire housing. Thus, the plastic provides the structural rigidity and barrier layer 70 applied thereover provides the moisture resistance.

It should be appreciated that the barrier layer formation processes described herein reduce the likelihood of thermal degradation of a plastic housing or fiber jacket 24 and the adhesive material forming mass 62.

The present invention thus provides a package for a fiber optic device that hermetically seals coupling region 12 a from external environmental conditions. Since a continuous layer of metal exists over the ends of glass tube 52 and substrate 32, mass 62 and fibers 22 that extend through mass 62, the likelihood of water vapor or some component, constituent or by-product of water vapor penetrating into the interior of tube 52 and the area surrounding coupling region 12a is significantly reduced, if not prevented. It will be appreciated by those skilled in the art that a moisture barrier results from the continuous layer of metal that exists at least over the end of glass tube 52, mass 62 and over outer jackets or buffers 24 of optical fibers 22, and preferably completely encapsulates the fiber optic device.

It should be appreciated that additional moisture protection may be provided by positioning an outer sleeve to encase glass tube 52. For instance, the outer sleeve may be cylindrical in shape and have an inner diameter closely matching the outer diameter of glass tube 52, but leaving sufficient space to accommodate barrier layer 70. The outer sleeve is preferably formed of a metal or rigid plastic to provide additional protection to glass tube 52 containing coupler 12. Moreover, an additional barrier layer may be formed over the outer sleeve to provide a second barrier layer.

The present invention will now be further described by way of the following examples:

### EXAMPLE 1

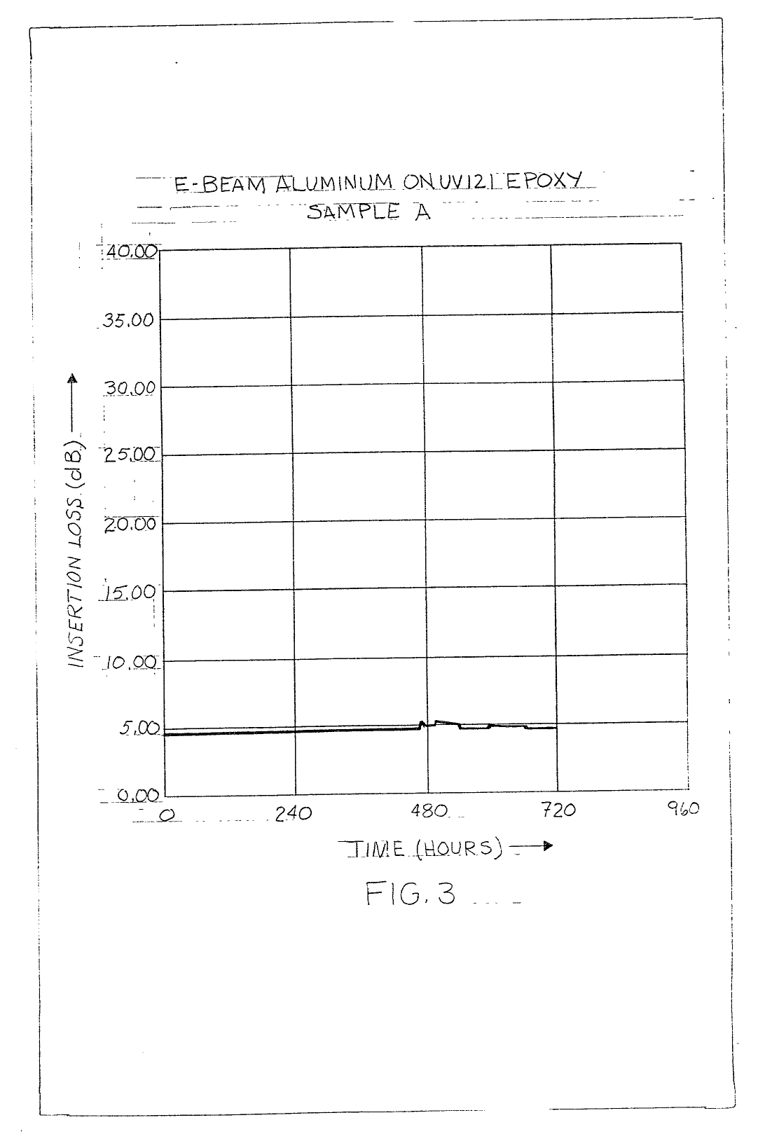

FIG. 3 provides the results of a damp/heat soak test, wherein a fiber optic component housed in a glass tube according to the present invention is exposed to elevated temperature and humidity conditions for an extended period of time. Data are collected for one output fiber. The graph shown in FIG. 3 illustrates the change in insertion loss for a fiber optic coupler housed in an enclosure having a moisture barrier layer formed solely of an aluminum metal layer, and with preliminary ion-beam sputter cleaning, wherein the aluminum is deposited by ion-beam enhanced electron beam deposition.

| | |
|---|---|
| Cleaning Process: | Oxygen Ion Beam Sputter Cleaning |
| Adhesive/Sealant | UV121 EPOXY |
| Material (mass 62): | |
| Layer Formation Process: | Electron beam deposition of aluminum |
| Layer Thickness: | 300 nm |

It will be appreciated that the vacuum deposition conditions for formation of the layer are conventional, and are well known to those skilled in the art.

As can be observed from FIG. 3, insertion loss is greatly minimized for a 720 hour period.

### EXAMPLE 2

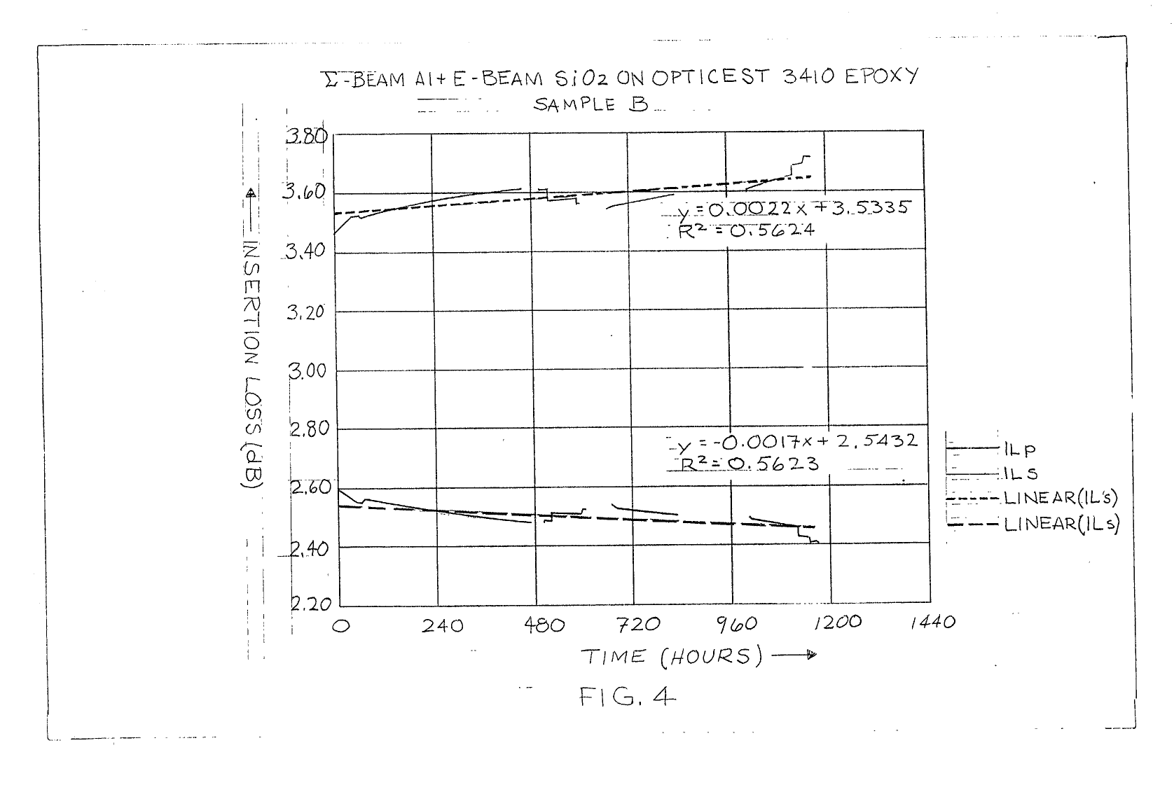

FIG. 4 also provides the results of a damp/heat soak test, wherein a fiber optic component housed in a glass tube according to the present invention is exposed to elevated temperature and humidity conditions for an extended period of time. Data are collected for two output fibers. The graph shown in FIG. 4 illustrates the change in insertion loss for a fiber optic coupler having a moisture barrier layer formed of two layers (i.e., the second layer on top of the first layer), and with preliminary ion-beam sputter cleaning. The first layer is an aluminum (Al) metal layer, while the second layer is a silica (SiO₂) metal oxide layer.

Parameters—SAMPLE B

| | |
|---|---|
| Cleaning Process: | Oxygen Ion Beam Sputter Cleaning |
| Adhesive/Sealant | Opticast 3410 EPOXY |
| Material (mass 62): | |
| Layer #1 Formation Process: | Electron beam deposition of aluminum |
| Layer #2 Formation Process: | Ion beam (oxygen) assisted electron beam |
| | deposition of silicon dioxide (SiO₂) |
| Layer #1 Thickness: | 300 nm |
| Layer #2 Thickness: | 150 nm |
| Ion Beam Energy: | 600-1200 eV |
| | (Oxygen beam, preferably 600 eV) |
| | (Argon beam, approximately 1200 eV) |
| Ion Beam Current Density: | 0.1-1.0 A/m2 |
| | (Oxygen beam, preferably 0.15 to 0.4 |
| | A/m2) |
| Ion Gun angle of incidence: | 30 degrees |
| Chamber base pressure: | <1 × 10 exp −4 Pa |
| Aluminum deposition rate: | 2 nm/sec |
| SiO₂ deposition rate: | 1 nm/sec |

It will be appreciated that the vacuum deposition conditions for formation of the layers are conventional, and are well known to those skilled in the art.

As can be observed from FIG. 4, insertion loss is greatly minimized for a period of 1200 hours.

Other modifications and alterations will occur to others upon their reading and understanding of the specification. It is intended that all such modifications and alterations be included insofar as they come within the scope of the invention as claimed or the equivalents thereof.

Having described the invention, the following is claimed:

1. A method of packaging a fiber optic device having at least one optical fiber extending therefrom, comprising the steps of:
a) mounting a fiber optic device having at least one optical fiber extending therefrom onto a substrate;
b) enclosing said fiber optic device within a cavity in a structure having at least one opening therein through which said at least one optical fiber extends; and
c) depositing a thin film of one or more target materials to form a generally continuous moisture impervious barrier layer over at least said opening and said optical fiber, wherein said barrier layer is comprised of one or more layers, and closes said opening in said structure and seals said cavity.

2. A method of packaging as defined in claim 1, wherein said step of depositing the thin film includes a process selected from the group consisting of: electron-beam deposition, evaporation, sputtering, and ion-beam assisted deposition.

3. A method of packaging as defined in claim 2, wherein said ion-beam assisted deposition process includes the steps of:
evaporating a selected target material; and
simultaneously ionizing a gas to produce an ion beam to accelerate the evaporated, selected target material.

4. A method of packaging as defined in claim 1, wherein said structure is a tube containing said substrate.

5. A method of packaging as defined in claim 4, wherein said tube is formed of a material selected from the group consisting of: glass, quartz, plastic and metal.

6. A method of packaging as defined in claim 3, wherein said one or more target materials includes a metal.

7. A method of packaging as defined in claim 6, wherein said metal is selected from the group consisting of: aluminum, zinc, copper, nickel, tin, tin/lead, tin/zinc, aluminum bronze, phosphor bronze, steel, stainless steel, monel, gold, molybdenum, titanium, chromium, silver, palladium, zirconium, silicon, tungsten, tantalum, boron, vanadium, cobalt, magnesium, magnetic metal, and metal alloys thereof.

8. A method of packaging as defined in claim 1, wherein said one or more target materials includes a ceramic.

9. A method of packaging as defined in claim 8, wherein said ceramic is selected from the group consisting of: metal oxides, metal nitrides and metal carbides.

10. A method of packaging as defined in claim 9, wherein said metal oxides are selected from the group consisting of: silica, silicon monoxide, alumina, titania, alumina-titania, zirconia, mullite, nickel oxide, chromium oxide, cerium dioxide, magnesium oxide, zinc oxide, and mixtures thereof.

11. A method of packaging as defined in claim 9, wherein said metal nitrides are selected from the group consisting of: aluminum nitride, silicon nitride, boron nitride and mixtures thereof.

12. A method of packaging as defined in claim 9, wherein said metal carbides are selected from the group consisting of: molybdenum carbide, tungsten carbide, titanium carbide, vanadium carbide, diamond-like carbon (DLC) and mixtures thereof.

13. A method of packaging as defined in claim 1, wherein said one or more target materials includes a glass.

14. A method of packaging as defined in claim 13, wherein said glass is selected from the group consisting of: soda-lime glass, lead glass, borosilicate glass, aluminosilicate glass, and fused silica glass.

15. A method of packaging as defined in claim 3, wherein said gas is selected from the group consisting of: argon, oxygen and nitrogen.

16. A method of packaging as defined in claim 1, wherein said one or more layers includes at least one of: a metal layer, a ceramic layer, a glass layer, a cermet layer, and combinations thereof.

17. A method of packaging as defined in claim 1, wherein said method further comprises sputter cleaning at least said opening and said optical fiber with an ion beam prior to forming said generally continuous barrier layer.

18. A packaged, optical device, comprised of:
an optical device having at least one optical fiber extending therefrom;
a structurally rigid housing encasing said optical device, said housing having an internal cavity for containing said optical device and at least one opening in said housing communicating with said cavity, said optical fiber extending through said opening; and
a continuous, barrier layer on said housing at least in the vicinity of said opening, said barrier layer covering said housing in the vicinity of said opening and a portion of the optical fiber extending through said opening and covering said opening to seal said optical device within said housing, wherein one or more layers are deposited using a thin film deposition process to form said barrier layer.

19. A packaged, optical device as defined in claim 18, wherein said one or more layers are formed by a thin film deposition process selected from the group consisting of: electron-beam deposition, evaporation, sputtering, and ion-beam assisted deposition.

20. A packaged, optical device as defined in claim 19, wherein said ion-beam assisted deposition includes evaporation of a selected target material, and simultaneous ionization of a gas to produce an ion beam to accelerate the one or more selected target materials.

21. A packaged, optical device as defined in claim 18, wherein said housing is a tube having an opening at each end thereof.

22. A packaged, optical device as defined in claim 21, wherein said tube is formed of a material selected from the group consisting of: glass, quartz, plastic and metal.

23. A packaged, optical device as defined in claim 18, wherein said layer is comprised of a metal.

24. A packaged, optical device as defined in claim 23, wherein said metal is selected from the group consisting of.: aluminum, zinc, copper, nickel, tin, tin/lead, tin/zinc, aluminum bronze, phosphor bronze, steel, stainless steel, monel, gold, molybdenum, titanium, chromium, silver, palladium, zirconium, silicon, tungsten, tantalum, boron, vanadium, cobalt, magnesium, magnetic metal, and metal alloys thereof.

25. A packaged, optical device as defined in claim 18, wherein said layer is comprised of a ceramic.

26. A packaged, optical device as defined in claim 25, wherein said ceramic is selected from the group consisting of: metal oxides, metal nitrides and metal carbides

27. A packaged, optical device as defined in claim 26, wherein said metal oxides are selected from the group consisting of: silica, silicon monoxide, alumina, titania, alumina-titania, zirconia, mullite, nickel oxide, chromium oxide, cerium dioxide, magnesium oxide, zinc oxide, and mixtures thereof.

28. A packaged, optical device as defined in claim 26, wherein said metal nitrides are selected from the group consisting of: aluminum nitride, silicon nitride, boron nitride and mixtures thereof.

29. A packaged, optical device as defined in claim 26, wherein said metal carbides are selected from the group consisting of: molybdenum carbide, tungsten carbide, titanium carbide, vanadium carbide, diamond-like carbon (DLC) and mixtures thereof.

30. A packaged, optical device as defined in claim 18, wherein said layer is comprised of a glass.

31. A packaged, optical device as defined in claim 30, wherein said glass is selected from the group consisting of: soda-lime glass, lead glass, borosilicate glass, aluminosilicate glass, and fused silica glass.

32. A packaged, optical device as defined in claim 20, wherein said gas is selected from the group consisting of: argon, oxygen and nitrogen.

33. A packaged, optical device as defined in claim 18, wherein said one or more layers includes at least one of: a metal layer, a ceramic layer, a glass layer, a cermet layer, or combinations thereof.

34. A packaged, optical device as defined in claim 18, wherein at least said housing is sputter cleaned with an ion beam prior to forming said barrier layer.
